(19) United States
(12) Patent Application Publication
(10) Pub. No.: US 2004/0152062 A1
(43) Pub. Date: Aug. 5, 2004

(54) Web-based learning and literacy education using core constructs and constructive surfing

(76) Inventor: Milton N. Adams, New York, NY (US)

Correspondence Address: Otho B. Ross, 28th Floor, 600 Third Avenue, New York, NY, 10016, US

(21) Appl. No.: 10/356,888

(22) Filed: Feb. 3, 2003

(51) Int. Cl. G09B 7/00

(52) U.S. Cl. 434/336

(57) ABSTRACT

The present invention relates to a method for establishing, organizing, managing and utilizing an online learning community and other resources to promote critical thinking skills. It provides online resources in critical thinking to individual learners, communities, and institutions, worldwide. The method is available as a tutorial resource, a supplementary instruction unit, and an integral curriculum in critical thinking for teachers, learners, writers, illustrators, artists and others.

### FIELD OF THE INVENTION

This invention relates to online learning and pedagogical methods intended to help improve basic literacy and critical thinking skills.

### BACKGROUND OF THE INVENTION

New media generate new requirements and new pedagogies. For example, the abacus and the printing press created a public need for a literacy of numbers and words. Inexpensive electronic calculators improved upon the abacus and spread numeric precision around the world. However, the goal of universal literacy in reading has remained constrained in parts of the world by the costs of modern publishing: in much of the world, children and adults who gain the fundamentals are unable to sustain and enhance their reading skills because books, magazines, and newspapers are unaffordable.

The emergence of the World Wide Web has created an unprecedented opportunity for universal, worldwide literacy, and its diffusion engenders a shift to a new pedagogy that builds upon the power of the Internet and Web-based learning communities. The method of the present invention, particularly the “constructive surfing” approach (described in more detail below) is experiential, multidimensional, and cross-disciplinary. It is a unique system of pedagogy designed to bring the resources of the Web to bear upon the challenges of education worldwide.

There are two popular schools of thought about basic literacy. The present invention introduces a third way.

The first literacy paradigm is the “preparedness for reading” approach (PFR), with its emphasis on teaching students how to read (and write) as a prerequisite for lifelong, text-based learning. The second paradigm, called “cultural literacy,” addresses the next logical question: “What should we all be reading?” It argues that a commonly shared, classical, literary canon—spanning the great thought of Western Civilization—is needed to create and sustain informed communities, civilized dialogue and moral debate.

For several decades, the preparedness for reading (PFR) paradigm has been characterized by passionate public debate among advocates of its two dominant, competing approaches to reading instruction: whole language vs. phonics.

Whole language programs emphasize literature, word meanings, critical thinking strategies, and self-expression; in the younger grades, children use invented spelling to author their own stories. Phonics programs emphasize word analysis, stressing the decoding of letter sounds and their combinations. Each approach has its shortcomings when used exclusively. Some phonics programs use low-interest reading material and boring worksheets. In whole language systems where phonics is left out, students often guess or skip over words they don't easily recognize, and some children may fail to effectively learn how to read.

Pickering (1989) describes “whole language” as a new term for literacy instruction that emphasizes the application of reading and writing in meaningful contexts. He argues that the theoretical base for whole language is closely related to key ideas of language experience and psycholinguistics, but that whole language represents a new paradigm.

Delcamp (1987) reviews the history of phonics and whole word instruction, arguing that students' reading proficiency does benefit from learning the fundamentals of phonics. Comparing the skills of third grade students who had received whole-language instruction since they began to learn to read with third graders enrolled in a phonics program, Bruck et al. (1998) found that the phonics group produced more accurate word spellings. He also found that their spelling of nonwords contained more conventional, phonologically accurate patterns.

The growing consensus is that a more balanced approach is needed that incorporates the best of both paradigms in early reading instruction: Svenson (2001); Ediger (1999); Sherman (1998). Baumann et al. (1998) find that teachers in a nationwide survey generally do not adopt an either/or approach to phonics and whole language, providing children, instead, with a balanced, eclectic program, offering both reading skill instruction and immersion in enriched literacy experiences.

Kibby (1995) examines reading trends from 1840 to the 1990s and concludes that statements about a decline in literacy are wrong. Similarly, Vamum (1986) surveys the five literacy crises that have occurred since the Civil War, arguing that the widespread perception that a serious literacy problem existed in the United States could not be supported either by international or historical comparisons of student achievement. Hirsch (1986) interprets declines in verbal performance among top SAT scorers, as evidence of a literacy crisis in the 1980s.

E. D. Hirsch, Jr.,—“Cultural Literacy” (1988)—; and Allan Bloom, “The Closing of the American Mind” (1987), are the leading proponents of the “cultural literacy” movement, although its roots can be seen to go as far back as the venerable McGuffey Reader.

Hirsch (1988) makes the case that “cultural literacy” in the U.S. has eroded because the foundations of a shared culture are no longer being established in our school system. He argues in favor of a shared cultural canon; one is “culturally literate” if one is familiar with the canon. He includes an appendix to the book entitled “What Literate Americans Know: A Preliminary List.” Meant to serve as a reference for national curricular change, the list has been criticized as reflecting only the dominant culture, while short-changing the multiple cultural heritages that comprise our nation.

In “The Closing of the American Mind” (1987) Bloom critiques the state of American higher education. He argues that the knowledge explosion and increasing specialization have not filled up the college years but emptied them. Far from creating open-minded students, he argues that the tendency toward cultural relativism has closed the American mind to a belief in moral values. Bloom contends that a reading of original texts allows one to form a vital understanding of issues that shallow summaries and abstracts do not. He proposes to re-invigorate college curriculums with the original text of “Great Books.”

The quest for common American reading materials to instill a shared foundation of knowledge, values and beliefs can be traced back almost two hundred years in America to the popularity of the McGuffey “Eclectic Readers” introduced in 1837. Over 122 million copies were published before their popularity declined in the 1920s. They have never actually gone out of print and, as of 1978, were still in use.

Originally the work of William Holmes McGuffey, who was born in 1800 on the Ohio frontier, the first McGuffey's readers that appeared in 1837 consisted of a primer, four readers, and a speller. The readers had pictures on every page and stories almost always had a moral and a connection to God. Over the next 83 years six graded readers were produced and revised frequently. McGuffey's Readers are credited with helping standardize education, spelling, and language. Norstad (1995) notes that “Their success at helping to shape the morality, culture, and literacy of American children presents a fascinating and instructive lesson for today's educators.”

In the 20th Century, the operative question was: How early might critical thinking skills be taught to children, so as to improve general literacy? This question is still being asked today.

### SUMMARY OF THE INVENTION

The present invention takes advantage of the enormous capabilities of the Internet and World Wide Web, and relates to a method for establishing, organizing, managing and utilizing an online learning community and other resources to promote a new approach to literacy that engenders critical thinking skills through Web surfing. It provides online resources in critical thinking to individual learners, communities, and institutions, worldwide. The method is available as a tutorial resource, a supplementary instruction unit, and an integral curriculum for teachers, learners, writers, and illustrators.

What is meant by the expression, “surfing” the Web? The World Wide Web was commercialized about a decade ago in 1994 with the introduction of the Mosaic Web browser. Mosaic provided its users with direct access to a graphic rich media environment of Web pages by simply typing in the URL address of the desired Website into its address bar, or by clicking one of the hyperlinks embedded in a page. The term “surfing the Web” refers to the practice of discovering the Web's content by simply, casually clicking the hyperlinks of rendered pages, one after another, recreationally, and thereby exploring this new multimedia world in an effortless, non-linear manner. This mode of exploration often led users to linked Web pages full of surprise and insight from distant countries, innovative start-up companies, obscure personal Web pages, government documentation, and esoteric knowledge bases. Metaphorically speaking, in those early days of a new mass medium, it was like surfing an ocean wave and enjoying its unique trajectory, regardless of where it might lead. Web surfing was, in effect, an experiential method of “discovery learning.”

In the present invention, “constructive surfing” refers to a similar mode of exploring and discovering the Web's content through the casual, intuitive, process of simply clicking hyperlinks.

That process is enhanced in the present invention by a set of construct matrices—built and maintained by subscribers—to provide a set of cognitive maps and conceptual grid points that organize the Web's eclectic content into an intuitive, easily navigated knowledge base that is built upon the theory of construct literacy. This improved method of surfing the Web validates and profits from the realization that certain “broadband” constructs have sufficient breadth and depth of meaning to easily extend our initial understanding of them across multiple disciplines and into new subject areas.

In a preferred embodiment, the method of the invention (sometimes referred to herein as “Pageant”) uses the resources of a Website and other areas to develop and refine a new pedagogical method for critical thinking called “constructive surfing,” which draws upon certain “core constructs” found in various areas of knowledge. Sample core constructs are provided in this application. The invention provides a mechanism for a compendium of core constructs to be further developed and refined by an online community of experienced educators. Once validated, the core constructs are organized and presented in the form of matrices that are available at a Web site or elsewhere. A user with a computer and Web browser may select one of several construct matrices to surf a set of links embedded in its cells that connect users to a Pageant archive server containing Web pages from across the Internet that provide myriad examples and illustrations of that construct. Subscribers to this service—“members” who purchase a customized browser built for this system—will be able to rate the illustrative pages they encounter within a matrix, participate in discussion forums, and post illustrative Web pages to the Pageant archive server for inclusion within the matrices. This is called indexing.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is an example of a “Construct by Subject Matrix” used in the present invention;

FIG. 2 is an example of a “Construct by Level of Difficulty Matrix” used in the present invention;

FIG. 3 is an example of a “Construct by Construct Matrix” used in the present invention;

FIG. 4 is an example of a “Construct by Timeline Matrix” used in the present invention;

FIG. 5 is an example of a matrix that shows the construct “Adaptation” across all subject areas;

FIG. 6 is an example of a matrix that also highlights the construct “Adaptation” across all subject areas; the function that sorts the data by level of difficulty is invoked from a drop down menu;

FIG. 7 is another example of a matrix that shows the construct “Adaptation” across all subject areas; the function sorting the data by timeline is invoked from a drop down menu;

FIG. 8 is an example of a navigation bar displayed at a Website, used in one embodiment of the present invention; and

FIG. 9 is an example of a navigation bar employed within a customized Web browser, used in one embodiment of the present invention.

### DETAILED DESCRIPTION OF THE INVENTION

Introduction

The present invention proposes an approach to basic literacy that is different from the traditional PFR and cultural literacy schools of thought. It is sometimes referred to herein as “construct literacy.” The invention uses a method called “constructive surfing” to fully harness the illuminating powers of the Internet in a pedagogical system designed for participation in the Information Age.

What are constructs? Concepts and constructs are abstract words that enable us to share ideas and build theories. Whereas concepts—like “liquid,” “vapor” and “solid”—refer to observable objects or states, constructs often do not. Words like “evolution,” “ego,” “continuity,” “self-esteem,” “integration” and “adaptation” are pure abstractions, created by and residing in the human mind. Yet, they are the building blocks of all theories. All scientific models have unobservable theoretical constructs at their core.

The primary aim of construct literacy is to provide students in K-12 systems—and home-based learning programs—with a powerful, efficacious conceptual vocabulary of 200 to 500 constructs or concepts that are delineated and validated for their broad expository power across multiple disciplines. It can also be used by adults engaged in self-directed learning. These constructs are referred to herein as “broadband constructs” or “core constructs.” Once these broadband constructs are learned in one instance, they provide valuable, immediate insight into parallel and or related constructs and processes in other fields and disciplines. Examples of broadband constructs may include: “argument,” “boundaries,” “cell,” “circulation”, “code,” “conservation,” “cycle,” “derivative,” “equilibrium,” “generation,” “growth” and many others. A list of some sample core constructs is set forth later in this application.

In a feature of the invention, these constructs are intended to be further “validated” (developed, refined and confirmed) by an online community of experienced educators and experts from many disciplines. This process is initiated when a member proposes a construct to the community in one of its member forums. Next, with the consensus of the group, the construct is listed in the compendium of core constructs. Members then surf the Web, using search engines, directories and other means to find a convincing array of instances of that construct that traverse a substantial number of disciplines and subject areas, establishing its breadth. These Web pages, documenting the breadth of a construct, are indexed to the Pageant archive server, a mirror site that stores and serves indexed pages for users. When members determine that sufficient documentation has been indexed to demonstrate its breadth, the construct is deemed de facto “validated.”

Once validated, these constructs are presented at a website in a multidimensional “surfing matrix” that encourages students to explore myriad illustrated examples of each construct across multiple disciplines, by level of difficulty, and along a timeline. This is called constructive surfing.

The constructive surfing approach of the present invention effectively builds upon and enhances the traditional PFR and cultural literacy paradigms in several ways. First of all, the introduction of broadband constructs at the elementary grades enables pupils to make the most of their partial literacy during their early years. Moreover, mastery of the core constructs establishes a shared conceptual language for dialogue and dialectics among students and educators far more quickly and more effectively than reading a canon of classic books. Cognizant that a student population has mastered this core conceptual vocabulary, publishers can employ these constructs in their instructional materials to define and describe virtually all other phenomena.

Construct literacy generates considerable synergies and brings many benefits to a learning community of students, educators, curriculum designers, publishers and artists. For students, construct literacy provides a coherent, unifying thread to classroom studies and self-directed learning. Instructors gain an effective strategy for team teaching that is easily planned and implemented. Construct literacy also provides curriculum developers with a useful, unobtrusive vehicle to introduce and reinforce critical thinking skills in schools. It enables editors of textbooks and other instructional materials to better target their offerings to the conceptual language of their readers. Collectively, these benefits improve and accelerate the learning experience.

Theory

As noted earlier, in much of the world, many children and adults who gain fundamental reading skills are unable to sustain and enhance their skills because printed books, magazines, and newspapers are unaffordable. Web publishing can resolve this conundrum in the 21^{st} Century for people who can access the Internet. By extension, universal literacy will require universal Internet access.

Economic considerations favor Web diffusion to schools, cyber cafes, and other public access settings, much like the early diffusion of the radio, telephone, and television. In many parts of the world, new cyber cafes are being established at an accelerated rate—over a thousand a month in Asia—providing low-cost, pay-for-use access to walk-in customers.

But, the shift to the Web for information will foster demands for either censorship or a higher standard of literacy. For, unlike other modern media, the Web is a largely unregulated network of independent publishers who are free to diffuse truth or fiction, information or disinformation, revelation or hoax, sound advice or quackery. Yet censorship is largely unworkable because it presumes that censors are as knowledgeable as “experts” in emerging fields. When engaging this medium, critical thinking is required.

Consider: the Internet was originally designed by scientists for scientists. Its users must determine the credibility of sources, assess the validity of statistical inferences, and consider alternative explanations for causal claims, either as individuals or within learning communities. The present invention provides a platform for developing these higher order cognitive skills.

What is critical thinking? Among cognitive theorists, Benjamin Bloom provides the most direct path to an appreciation of the idea of critical thinking. He identifies six cognitive levels, ranging from factual knowledge to evaluation. These are: (1) knowledge of facts, (2) comprehension, (3) application, (4) analysis, (5) synthesis, and (6) evaluation, and may be arranged in the following ascending order of sophistication:

Bloom's Taxonomy:

6. Evaluation

5. Synthesis

4. Analysis

3. Application

2. Comprehension

1. Knowledge of Facts

Levels one through three deal with facts and procedures and the demonstration of their mastery.

Critical thinking occurs at levels four, five, and six; these require higher-order skills. Inquiries posed at these levels develop and reinforce critical thinking. The broadband constructs used in the present invention promote reflection at these levels.

In the late 20th Century, the operative question was: How early might critical thinking skills be effectively taught to children? Today, the Web provides an unprecedented opportunity for self-paced, personalized instruction, enabling learners to advance through a curriculum at their own pace, progressing when they are ready, or curious.

Practice

Learning is reinforced, enhanced, and extended by examples; the more the merrier. You can never have too many examples; and, the more diverse, the better. But, time and space constraints often limit the number and scope of examples and illustrations of teachers and textbook editors. Neither dimension is a constraint on the Web, where hyperlinks provide an unparalleled and almost unlimited opportunity to “illustrate, illuminate and elucidate” any idea. This unique feature of the World Wide Web is of such significance in the evolution of education as to justify the development of a new pedagogical system to marshal its capacities.

The present invention builds upon this pedagogical virtue. It uses the Web to link core (broadband) constructs to a trove of information that can be “surfed” within a multi-dimensional matrix. In a preferred embodiment, the dimensions of the matrix comprise: discipline/subject, timeline, level of difficulty, and a construct by construct grid. Each core construct can be sorted by these dimensions. Using the matrices is called constructive surfing.

Core Constructs.

Core or broadband constructs may be thought of as very broad constructs or concepts with metaphoric scope—highly scalable and transferable ideas that often represent generic structures, processes or actions (SPA). They are more than just abstract categories or ideas. They may be called construct metaphors. Once grasped, they help illuminate ideas in other fields and disciplines, much like cognates convey similar meaning across different languages. They are elastic notions, concepts with reach that support a lifetime of learning. Because of their breadth, these constructs can be used very much like threads or themes for cross-disciplinary discourse.

Core constructs should not be confused with keywords or search terms that are commonly used with some Internet search engines and portals, such as Yahoo, Google, Altavista, etc. These search engines use popular categories that point users to timely “content” that is regularly updated, e.g., stock quotes, weather reports, bargains, movie listings, celebrity news, popular software, subscription policy, etc. By contrast, in the present invention, core constructs are linked to “meaning,” to timeless illustrations.

Two Types of Constructs.

There are two types of constructs featured in the Pageant compendium and its matrices. These are: a) first order constructs, and b) second order constructs. First-order constructs are concepts that currently span all or most disciplines. Second-order constructs span a limited number of disciplines. They contribute good depth of meaning, but with limited breadth of coverage. They are considered to have with strong potential for wider usage over time.

Some sample core constructs include:

Contract

Boundary

Circuit

Cycle

Derivative

Environment

Equilibrium

Leverage

Maintenance

Maturation

Rhythm

Safety

Union/alliance

A more complete compendium of constructs is given below. Due to their scope, core constructs work very much like threads or themes for cross-disciplinary studies. Consider the construct, “equilibrium.” The construct is found in many different, and sometimes totally unrelated, disciplines. For example, it is very useful in elucidating ideas like:

Atomic structure in chemistry

Algebraic equations

Sentence structure in English composition

Orchestral dynamics in music

Balance of power in American politics

The role of the Electoral College

The principles of composition in painting

One focus of the present invention is to delineate, validate, illustrate and make available for public use between 200 and 500 construct metaphors—certain foundation stones of the arts, sciences and humanities. This compendium of constructs is intended to be reduced or further expanded by members of an online community using discussion forums that are made available to experienced educators and experts through a Web site using a customized Web browser. Some additional sample core constructs, grouped by major field, are:

In the fields of economics and finance:

Rate of return

Diminishing returns

Cost/benefit

Cost effectiveness

Efficiency

Utility

Interest

Asset

Inflation

In the field of research:

Indicators

Measure

Methodology

Absolute

Causality

Variance

Validity

History

In the fields of design and engineering:

Form/function/material

Construction

Power

Energy

Structure

Stress

Resistance

In the fields of planning and evaluation:

Context/input/process/product

Scope/sequence/schedule

Challenge/opportunity

Constraints/resources

Needs

Accountancy

In the field of criminal justice:

Modus Operandi (MO)

Motive/Means/Opportunity (MMO)

Rules of evidence

Rules of order

Contract

In the field of physical sciences:

Polarity

Catalyst

Disintegration

In the field of social sciences:

Culture

System

Compendium of Core Constructs.

The following is a more complete list of sample core constructs. This compendium is neither exhaustive nor definitive, but rather is intended to be a starting point for discussion and consensus building. The online Website and its discussion forum provides a venue to merge redundancies and propose new constructs:

Adaptation

Adjustment

Agreement

Aggregate

Animation

Appreciation

Argument

Atmosphere

Bank

Base

Bay

Boundaries

Bridge

Capacity

Catalyst

Cell

Circulation

Code

Collateral

Collection

Command

Composition

Compression

Conflict

Confluence

Concentration

Conditions

Construction

Contraction

Control

Conservation

Conversion

Conveyance

Cooperative

Coordinates

Cycle

Definition

Depletion

Depression

Derivative

Detection

Development

Disintegration

Displacement

Divergence

Division

Dynamics

Energy

Equilibrium

Evolution

Exchange

Expansion

Exceptions

Experiment

Expression

Extension

Extraction

Force

Format

Formula

Frequency

Gate

Gauge

Generation

Growth

Hemisphere

Image

Indicator

Inherit

Inquiry

Instrument

Integration

Junction

Law

Map

Mass

Measure

Mechanics

Media

Migration

Model

Momentum

Navigation

Noise

Nomenclature

Origin

Orientation

Paradigm

Parallel

Particle

Path

Pivot

Potential

Power

Prediction

Preparations

Preservation

Pressure

Principles

Proof

Propagation

Protocols

Procedures

Properties

Proportion

Public

Pulse

Rate

Record

Remote

Reproduction

Resistance

Restoration

Restriction

Revolution

Rotation

Scarcity

Security

Shock

Signature

Solution

Space

Sphere

Standards

State

Stratification

Stress

Structure

Study

Substitution

Surprise

Suspension

Territory

Threshold

Tolerance

Trait

Transition

Trend

Treatment

Values

Validation

Variance

Verification

Violation

Waste

Wave

Weak

Construct Matrices and Constructive Surfing.

To surf “constructively” is to surf the Web by core constructs—to make the most of the Web's instructional potential, and to optimize its pedagogical promise.

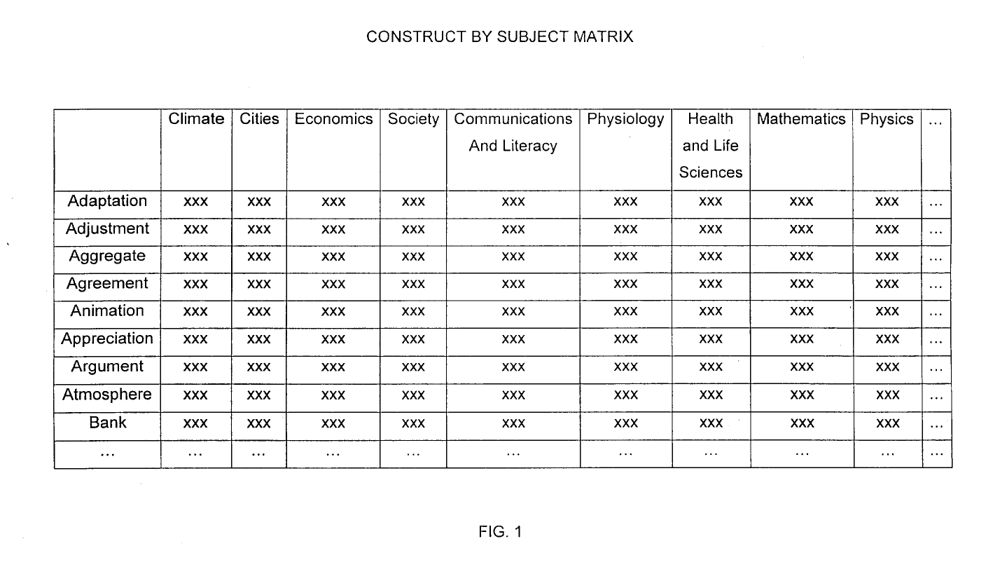

Using a preferred method of the present invention, following the initial validation of core constructs discussed above, the validated constructs are arranged into a matrix of cells on a Web site (set up and running on one or more servers or other Internet-connected computers) to enhance construct literacy. Several types of matrices are used, as shown in FIGS. 1-7.

FIG. 1 is an example of a “Construct by Subject Matrix,” used in the present invention (sometimes referred to herein as the “Pageant system”). In a preferred embodiment, this matrix displays all of the validated core constructs along its vertical axis; across its horizontal axis is an array of academic disciplines and subjects. This, and other figures, shows only a partial view of the entries along these two axes. This matrix serves as a practical starting point for a constructive surfing session. The cell located at the intersection of any given construct and subject contains an embedded hyperlink (illustrated as “xxx”). When clicked, that link will display a list of Web pages in a browser frame that have been indexed by Pageant members to illustrate how that construct is employed in that particular subject area. Users simply click the hyperlinks on the list, one after another, to explore the content of that cell. With the customized browser purchased by members—in this and in all other matrices—the listed Web pages are automatically loaded in a multi-page, tabbed browser.

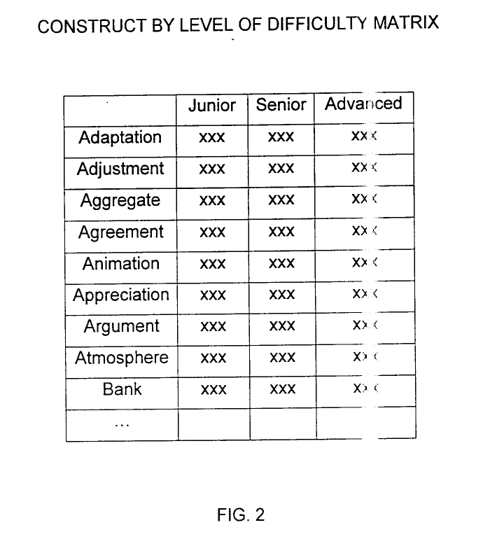

FIG. 2 is an example of a “Construct by Level of Difficulty Matrix,” used in the Pageant system.

This matrix displays all of the constructs along its vertical axis; three levels of difficulty are arrayed across its horizontal axis: Junior, Senior, and Advanced. The cell located at the intersection of any given construct and level of difficulty contains a link (xxx) that—when clicked—will display a list of hyperlinks to Web pages that have been indexed to the archive server by Pageant members to illustrate how that construct is employed at that particular level of difficulty across the subject areas. The “Junior” level will sort and list those indexed Web pages most appropriate for elementary school students; the “Senior” level will display examples appropriate for high school and college students; the “Advanced” level is appropriate for graduate students and researchers.

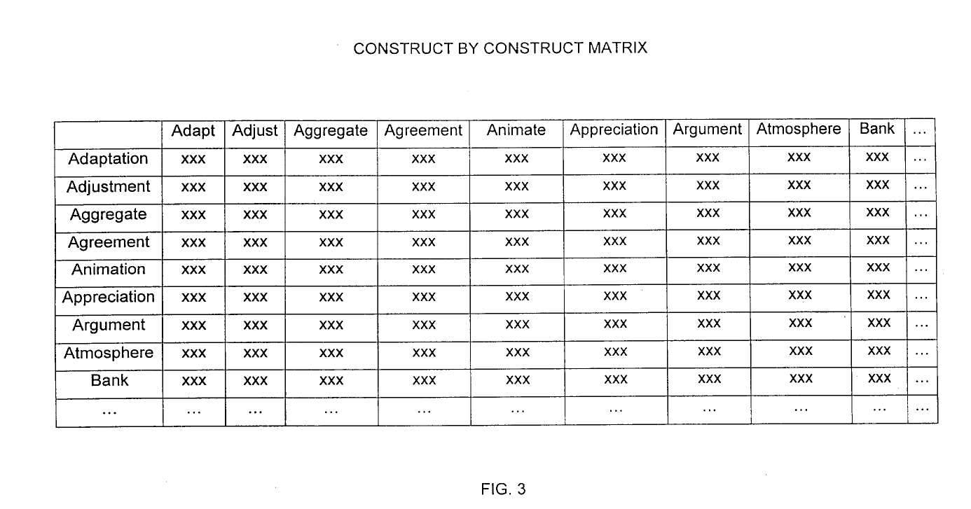

FIG. 3 is an example of a “Construct by Construct Matrix,” used in the Pageant system. This matrix displays all of the validated core constructs along its vertical axis; across its horizontal axis is a similar array of core constructs. The cell located at the intersection of any two constructs contains an embedded hyperlink (xxx) that—when clicked—will sort and display a list of Web pages that have been posted by Pageant members to its archive server that illustrate instances of interaction between the two selected constructs.

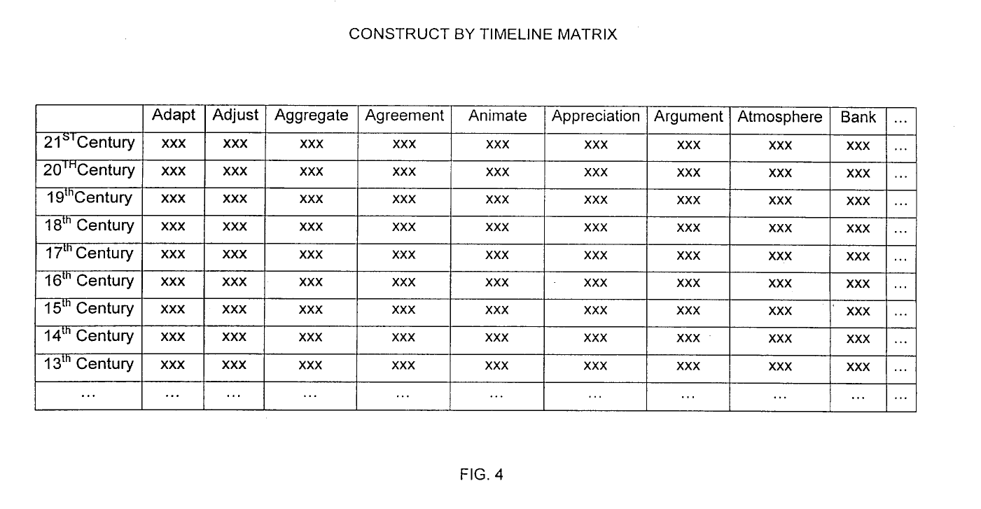

FIG. 4 is an example of a “Construct by Timeline Matrix,” used in the Pageant system. This matrix displays all of the validated core constructs across its horizontal axis; along its vertical axis is a chronological timeline. The cell located at the intersection of any time period and a construct contains an embedded hyperlink (xxx) that—when clicked—will sort and display a list of Web pages that have been indexed by Pageant members to illustrate either instances of that construct's use during a particular time period, or a discussion about that time period that employs the construct.

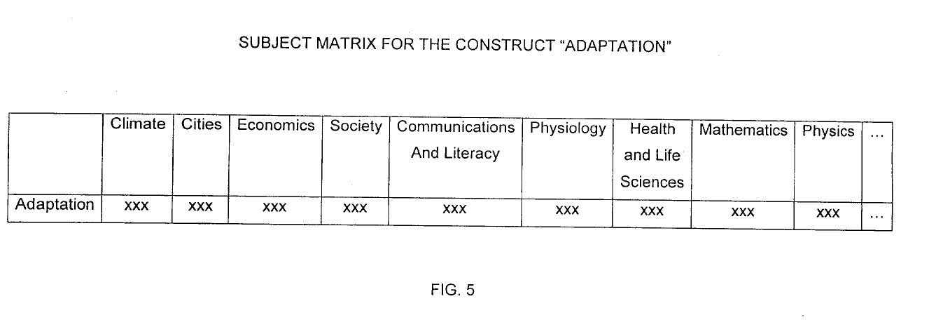

FIG. 5 is an example of a matrix that shows the construct “Adaptation” across all subject areas.

Users arrive at this matrix by clicking the construct “Adaptation” in the constructs by subject matrix (FIG. 1). Using a Construct by Construct matrix as a starting point, this view can also be invoked by clicking the cell that intersects Adaptation and Adaptation. By clicking the link (xxx) in any subject cell in this matrix, users are presented with a listing of hyperlinks to explore instances of how that construct is used in the selected area.

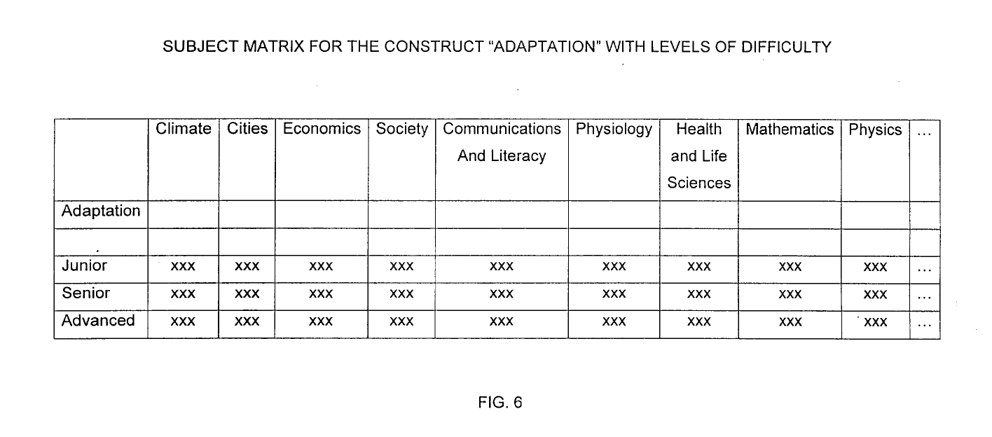

FIG. 6 is an example of a matrix that also highlights the construct “Adaptation” across all subject areas; the function that sorts the data by level of difficulty is invoked from a drop down menu.

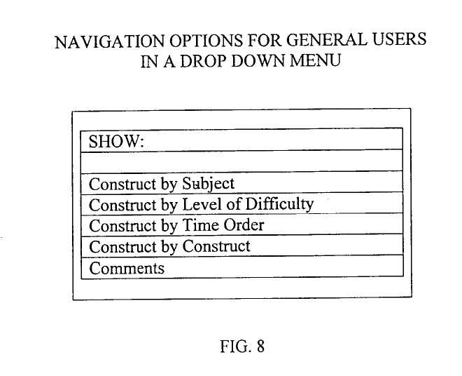

Users arrive at this matrix by first clicking the construct “Adaptation” within the construct by subject matrix, then choosing the option “SHOW: Construct by Level of Difficulty” from a drop down menu (see FIG. 8).

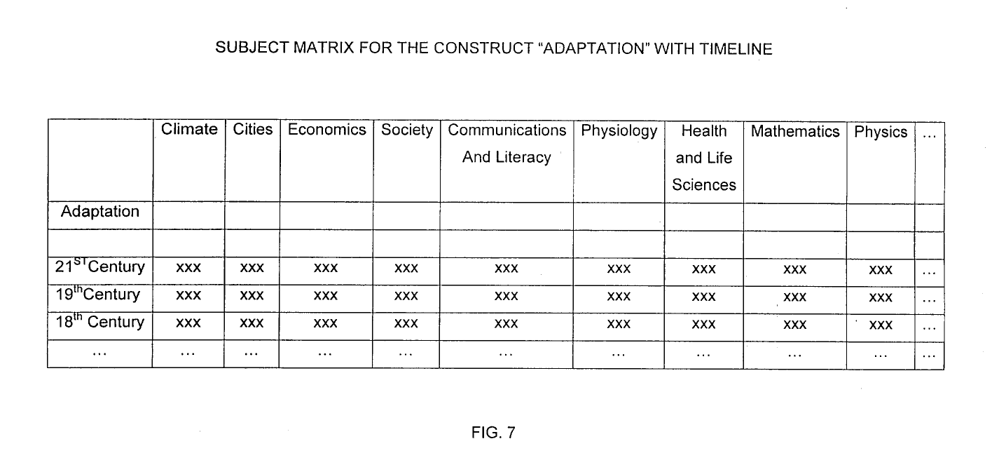

FIG. 7 is another example of a matrix that shows the construct “Adaptation” across all subject areas; the function sorting the data by timeline is invoked from a drop down menu. Users arrive at this matrix by clicking the construct “Adaptation” within the construct by subject matrix, then choosing the option “SHOW: Construct by Time Order” from a drop down menu (see FIG. 8). Using the construct by construct matrix as a starting point, this matrix can also be invoked by clicking the cell that intersects Adaptation and Adaptation, and then using the drop down menu.

FIG. 8 is an example of a navigation bar displayed at the Pageant Website. When general users access this Website, a browser frame appears on the screen with a drop down menu titled “Show.”It offers the option to surf by: subject, level of difficulty, time order, or within a construct by construct matrix; and to display comments related to the current Web page being viewed. These options can be activated at any point within a surfing session to re-sort the listings within a given cell.

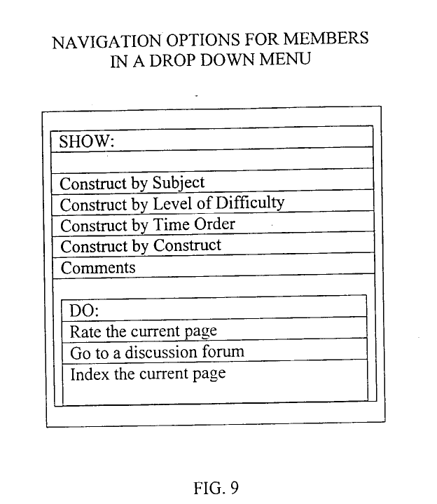

FIG. 9 is an example of a navigation bar employed within the customized browser of the Pageant system. When “members” activate their customized browsers, a frame appears on the screen that offers the same surfing options for general users that are displayed under the title, “Show.” In addition, the frame offers premium menu options under the title, “Do.” These options present the opportunity to: rate the current page within the Pageant system; go to a discussion forum; or index a Web page that the member is perusing, i.e., post a hyperlink to the archive server for inclusion in a cell in one of the matrices.

As previously mentioned, a sample matrix for the construct “Adaptation” is shown in FIG. 5. This type of subject matrix appears when the user clicks any construct at the construct literacy Website.

It encourages the user to explore an array of fields and disciplines. Since “adaptation” is a concept found in several different disciplines (such as climate, human physiology, genetics, literature), the major relevant disciplines may be arranged in a plurality of columns. For example, a visitor to the Web site will see the following columns for the construct “adaptation”: “Climate;” “Cities;” “Economics;” “Society;” “Communication and Literacy;” “Physiology;” “Health and Life Sciences;” “Mathematics;” and “Physics.”

At any point during a surfing session, users can sort the contents of the matrix they are viewing by two dimensions: level of difficulty, or by timeline. These sorting options are invoked from a drop down menu located on the screen as shown in FIG. 6 and FIG. 7. In the example shown in FIG. 6, there are three levels of difficulty, namely “Junior,” “Senior,” and “Advanced.” The Web pages presented within this list of hyperlinks are rated by members so as to be appropriate, respectively, for elementary school pupils, high school and college students, and graduate students and researchers.

A timeline (shown in FIG. 7) may also be invoked, if desired. The example in FIG. 7 shows a timeline for the construct “Adaptation” sorted by centuries. These listings would include both historical references wherein the construct was employed in a work from the designated century, as well as contemporary references that employ the construct in a discussion of certain events of that century. The timeline may be displayed in other practical units of time. For example, each block of the matrix may be divided by year or other time period, such as “2000—present;” “1950-1999;” “1900-1949;” “1850-1899;” “1700's;” “1600's;” “1500's;” etc.

Utilization Scenario

1. In the present invention, constructive surfing comprises two modes of operation: a) a website provides a system of frames to allow visitors to surf constructively within the system's matrices, and b) a customized Web browser allows paid subscribers (members) to surf constructively and to post Web pages to cells within the system's matrices (indexing), and other benefits. In both modes there is a navigation bar located somewhere on the user's screen that offers alternative views of its databases, sorting them along different dimensions such as timeline and level of difficulty. Upon arriving at the Pageant site, or upon opening the customized Pageant browser, the user can choose to surf within any matrix, and can change matrices at any time to reconfigure the data to another view.

2. Upon opening the customized Web browser or arriving at the Construct Literacy Website the user encounters the Pageant homepage that presents alternative ways to begin a constructive surfing session. Users can click a link that takes them to the Compendium of Constructs, a listing of all current constructs within the system, and choose one. When any of these constructs is clicked (e.g. “Adaptation”) a Construct by Subject Matrix appears on the screen for that particular construct (FIG. 5). Alternatively, a user may choose to initiate a surfing session by proceeding directly to a general Construct by Subject Matrix (FIG. 1) and clicking a construct. This will also generate a subject matrix for that construct.

3. At this point a user may wish to focus on a specific subject area for the construct “Adaptation,” such as “Climate.” When that cell is clicked it generates a listing of hyperlinks for all pertinent Web pages indexed to the system that document adaptation to climate. This list of URLs connects users to a trove of examples, illustrations, and lessons stored in the system's archive server. In the general user mode of operation, this list of hyperlinks appears as a frame along the horizontal or vertical axis of the Web page. The user can click down that list to peruse its offerings. If desired, the user can access the drop down menu and select the option to sort this listing by either level of difficulty and/or timeline, and the listing of links within the frame will be grouped accordingly.

4. In addition, the Web page provides direct links to current and past online discussions where students reinforce their learning experience through real-time discussions with peers and educators, or they can gain better insight into Web documents by reading the stored annotative comments of contributors. There is also a link to a resource center where teachers, parents, and learners may download source materials and lesson plans for use in settings without Internet access

5. The mode of operation for “members” functions differently when a cell within a matrix is activated. This group of users will have purchased a customized browser that utilizes the tabbed windows feature of one of several companies. When the cell is activated at the intersection of adaptation and climate, the browser will automatically load the listed pages for viewing as multiple, tabbed pages, in which the user can peruse one after the other by activating a function key or by simply clicking the labeled tabs.

6. This custom browser will be an enhanced browser product built by a development partner that maintains all of the multi-media functionality of its underlying core browser. Members will be able to use the customized Web browser for off-site, general Web use, as well, by typing a desired URL into its address bar and hitting the “enter” key, as with any other browser.

7. In the course of their general activities on the Web users will be able to index any Web page to a Pageant matrix. This is achieved by invoking the drop down menu, locating the “Do” function, and choosing the command “Index the current page” (see FIG. 9). Subsequent dialogue boxes will allow the member to specify the target location for the page in a specific cell of a specific matrix.

8. Members will pay a one-time fee to purchase of the customized browser, and they will pay a nominal annual membership fee for full participation in this community. Besides “indexing,” other features reserved for paid members include the opportunity to rate pages within the system, and access to an organizational forum that handles matters pertaining to the methodology of construct literacy and organizational policy governing the learning community.

Online Discussions and Forums

In normal operation, users may compose and post online text comments about various topics using a “Discussion Groups” interface displayed at the Web site. When invoked a frame appears on the screen listing all current discussion topics by title or subject line. If a user wishes to read the full text of a particular comment, the user “clicks” on that title, and the full text is then loaded and displayed. A “reply to” link also appears to allow the user to reply to the message so as to continue the discussion thread. In addition to reading and posting comments, the user may also search the entire database of posted comments by keyword or pattern. Discussion groups are used by students, educators and the general public. When users invoke the “SHOW: Comments” command from the drop down menu (see FIG. 8), it sorts the discussion groups database for comments associated with that particular article (Web page).

In another embodiment of the invention, a separate “Forum Group” is established for use by “members,” qualified educators, and experts for the purpose of developing, refining and validating the core constructs that are presented in matrix form on other pages of the Web site. Educators and experts may also add URLs of resource materials that are found to be particularly useful to certain constructs. To promote consensus in the validation process of the constructs and the resource materials, an online voting interface is also included on the “members” forum Web site.

Web Browser Interface.

In a preferred embodiment, constructive surfing within the method of the present invention is enabled through the use of customized Web browser software. A particularly useful browser is known as the “NetCaptor” browser commercially available from Stilesoft, Inc. This browser permits up to several dozen Web pages to be loaded simultaneously within a single browser view. Each page is associated with a tabbed window. Each tab displays a text label associated with that page, or a graphical icon, or both. The tabs may be arranged in a horizontal row across the top or bottom of the browser screen, or along the side, or in some other arrangement. Any tab can be selected to open its associated Web page with a curser click. Moreover, by activating one of two function keys on the computer keyboard, the user can shift either left or right along the row to automatically open the next loaded page. This arrangement permits the user to flip back and forth between Web pages instantly, without the need to wait for each Web page to be separately downloaded and rendered each time. This is an improvement over conventional browsers, which can take several seconds or minutes to load a Web page, depending upon how graphics-intensive the pages are, how fast the Internet connection is, and how fast the user's computer is. This arrangement is particularly useful for young children, who frequently have a short attention span. Using this browser arrangement, Web pages associated by construct may be arranged in a suitable order and arrangement for rapid navigation and improved learning.

Alternatively, another browser enhancer loads multiple Web pages, but instead of using tabs, it employs a scrollable horizontal tool bar located at the top or bottom of the browser to display the names of loaded pages. When the user clicks the label, it opens that page.

In another embodiment of the invention, a series of frames generated by a matrix cell is presented to the user. A frame is a series of Web pages that occupy the screen at the same time. Frames add excellent functionality to a Web site as a navigational tool that can be used to jump to a different section of a Web site or other Web sites. In effect, frames may be used as an interactive table of contents. Frames are typically used to divide the browser into two or more panes to help the user navigate. One of the panes usually contains an outline of the site with links. The user can click a link to view another page.

In this implementation, when a matrix cell is clicked, it will generate a frame within the browser. The links associated with the matrix cell will appear as a list within the navigational pane. When the user clicks a link, that page opens within the frame. The frame offers users the navigation option to view the “next” or “previous” page on the list, as well as other options for users.

Method Summary.

To summarize, a preferred embodiment of a method of the present invention comprises the following steps:

1. Establishing a Web site on a server connected to the Internet, the Web site providing interactive access to membership sections, online discussion forums and a database;

2. Inviting experienced educators, and interested learners and others to subscribe as members, so as to form an online community;

3. Storing an initial set of sample core constructs in the database;

4. Developing and refining the core constructs by inviting the educators and/or other members to discuss, document, and reach consensus on the validity of a set of core constructs judged necessary by the members for critical thinking and lifelong learning;

5. Inviting the members to locate significant Web sites illustrating each core construct, and to enter the uniform resource locator (URL) or link for each such site into the database, together with the educator's comments, if any, and any additional relevant materials deemed important by the member;

6. Downloading the Web pages recommended by members and copying them to an archive server that functions as a permanent storage base and a mirror site for the construct documentation and improves the access speed for users.

7. Arranging the core constructs, document URLs, comments and other materials into a set of construct matrices, and posting the construct matrices to the Web site, each matrix associated with one core construct, and each matrix having at least three navigable dimensions, including subject, level of difficulty and timeline; and

8. Presenting the matrices to a learner through a Web browser interface, or through a system of frames at a Website, in a manner that promotes constructive surfing intended to improve the learner's critical thinking skills and basic literacy.

Applications.

There are at least three primary applications for construct literacy activities:

1. Individual constructive surfing with a personal computer or an Internet appliance. This is the preferred approach because it allows each individual user to pursue a pedagogical experience congruent with personal needs and immediate interests.

2. Use by a teacher (such as with an LCD or other projector) to share Web resources with an entire class in those settings where there is only one available Internet device.

3. Inclusion in printed source books for settings without Internet access.

Benefits.

Some benefits and advantages of the present invention include, but are not limited to, the following:

Experiential learning. Browsing the Web is always a learning experience, though its insights and lessons are not always relevant to the user's interests and priorities at a particular moment. The present invention brings new focus to surfing, providing support for an experiential pedagogy that is guided by one's natural curiosity.

Self-paced learning. Once a construct is grasped in one matrix cell, the user can view examples in other disciplines and/or at higher levels of difficulty and application. Users advance through the Web pages at their own pace. They can drill down into the more advanced illustrations whenever they are ready or curious.

Cross-disciplinary learning. For example, a user can review examples of the construct of “efficiency” in the field of architecture, then surf horizontally within the matrix to review efficiency considerations in medicine, engineering, or manufacturing. This pattern reinforces learning, and exposes learners to new ideas, fields, and vocational paths.

Multidimensional learning. For example, consider a user surfing the construct, “code of conduct.”At an appropriate level of difficulty, the user navigates exemplary materials about the Ten Commandments, Hamarabi's Code, the Meditations of Marcus Aurelius, and the initiation rites of Masai warriors, among others. This multiplicity of instances provides a multidimensional perspective, fostering an open mind to the contributions of all civilizations, creating a bulwark against ethnocentrism.

Historical perspective. Constructive surfing along a timeline provides valuable insights into historical processes. For example, one cane note how the concern with “efficiency” considerations germinates, like a virus, from 19^{th} century manufacturers throughout most sectors of modern life.

Annotation. Since users can review the comments of those who contribute a Web page, this form of annotation offers a valuable context for the Web page, e.g., providing background information, irony, humor, and a point of view.

Conceptual vocabulary. The invention helps English literacy students acquire a high-level conceptual vocabulary that can accelerate their maturation to abstract thinking, inductive reasoning, and critical writing skills.

Team teaching. The invention strengthens the impact of team teachers working across the sciences and humanities.

Curricula integration. The invention helps integrate diverse curricula components within an instructional system.

Portable Storage Product Implementation

The Pageant System of the invention may also be packaged on CD-ROM, DVD and other portable storage media. In this embodiment, a partial Pageant Directory is copied to the portable storage product, reflecting a view of the system at a given point in time. The product also stores the Web pages associated with its core constructs. A user with this product and a browser gains a comparable experience of constructive surfing—without an Internet connection—but within a limited range of the matrix, determined by the storage capacity of the medium.

### CONCLUSION

In summary, construct literacy, as embodied in the present invention, is a powerful, compelling pedagogical system and method that complements and completes the two leading traditional approaches to literacy.

While the invention has been described herein with reference to certain preferred embodiments, these embodiments have been presented by way of example only, and not to limit the scope of the invention.

What is claimed is:

1. A method for online learning and literacy instruction, comprising:
(a) establishing a Web site on a server connected to the Internet, the Web site providing interactive access to membership sections, online discussion forums and a database;
(b) inviting experienced educators, interested learners and others to subscribe as members, so as to form an online community;
(c) storing an initial set of sample core constructs in the database;
(d) developing and refining the core constructs by inviting the members to discuss, document, and reach consensus on the validity of a set of core constructs judged necessary by the educators for critical thinking and lifelong learning;
(e) inviting the members to locate significant Web sites illustrating each core construct, and to enter the uniform resource locator (URL) or link for each such site into the database, together with the members' comments, if any, and any additional relevant materials deemed important by the members;
(f) arranging the core constructs, contributed URLs, comments and other materials into a set of construct matrices, and posting the construct matrices to the Web site, each matrix associated with one core construct, and each matrix having at least three navigable dimensions, including discipline, level of difficulty and timeline; and
(g) presenting the matrices to a learner through a Web browser interface, in a manner that promotes constructive surfing intended to improve the learner's critical thinking skills and basic literacy.

2. A system of literacy learning: comprising; a compendium of up to 500 core constructs with broad expository reach that find natural expression across multiple disciplines and subject areas, and whose mastery represents a level of literacy.

3. A method for organizing, indexing, and accessing an Internet subject directory about the Web's contents; comprising: the use of a multidimensional construct matrix as its navigable graphic user interface (GUI) that employs broad search terms representing generic structures, processes, and actions (SPA terms) to organize, sort and display information generated by a community of users.

4. A method for organizing and displaying information from a database about the Web's content for online learning; comprising: the use of a construct matrix of generic SPA terms as the GUI that employs a user controlled pivot table to present different summary cross tabulation views of information from its database, including the display of data within a construct by construct table.

5. A system for organizing and presenting an Internet home page or portal for public and commercial interactions; comprising: the use of a construct matrix of generic SPA terms as the GUI that employs a user controlled pivot table to present different summary cross tabulation views of information from its database, including the presentation of data within a construct by construct table.

6. A system of navigating the Internet called constructive surfing; comprising: the aforementioned Web portal and subject directory systems, and a customized Web browser or system of frames that automatically opens and tabs the lists of Web addresses generated by the directory.
